(19) United States
(12) Patent Application Publication
(10) Pub. No.: US 2005/0259315 A1
(43) Pub. Date: Nov. 24, 2005

(54) Cascaded raman pump for raman amplification in optical systems

(76) Inventors: Alexis Debut, Milano (IT); Massimo Artiglia, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/515,833

(22) PCT Filed: May 31, 2002
(86) PCT No.: PCT/EP02/06029

§ 371 Date: Jun. 20, 2005

(51) Int. Cl. H01S 3/00

(52) U.S. Cl. 359/334

(57) ABSTRACT

A pumping module having a cascaded Raman laser for Raman amplified optical transmission systems. Non-linear parametric phenomena, such as Raman-assisted three-wave mixing, in Raman amplified signals from a cascaded Raman pump are strongly reduced by substantially suppressing from the output spectrum of the Raman pump the emission peaks at wavelengths shorter than that of the desired pumping wave on a specific wavelength λₙ, and within a given spacing from λₙ. The pumping non-zero dispersion fibres have zero dispersion between the wavelength range of the transmission signal and the wavelength range of the pump signal.

### BACKGROUND OF THE INVENTION

The invention relates to a cascaded Raman pumping source for a Raman-amplified transmission system. More generally, the invention concerns an optical fibre communication system employing Raman amplification.

Distributed Raman amplification is becoming increasingly important in optical communication systems, in particular in high-bit rate wavelength division multiplexing (WDM) systems. An important advantage of distributed amplification is that the effective optical signal-to-noise ratio is significantly lower than that of a discrete amplifier, e.g., an erbium-doped fibre amplifier (EDFA), having the same gain.

Raman amplifiers as well as Raman lasers take advantage of stimulated Raman scattering (SRS), a non linear effect that can cause broadband optical gain in optical fibres. SRS can be used to amplify an optical signal at a certain wavelength by the use of a strong radiation at a lower wavelength, called the pump radiation. Raman gain results from the interaction of intense fight with optical phonons of the glass constituting an optical fibre. The transmission fibre itself is used as an amplifying medium for signals as they travel towards a repeater or a receiving terminal and the resulting gain is distributed over a length (typically tens of kilometres) of the fibre.

Recently, attention has been drawn also to optical transmission systems employing discrete, or lumped, Raman amplification. One of the advantages of using discrete Raman amplifiers over the more conventional EDFAs is the possibility of expansion into the S-band (short-wavelength band, about 1460-1530 nm) of signal wavelengths.

An example of a transmission system with a discrete Raman fibre amplifier is given in U.S. Pat. No. 6,310,716.

Raman scattering is the inelastic scattering of light by optical phonons, which are the vibrational modes of the material. In Raman scattering an incident photon of a certain frequency is converted to another photon at a frequency shifted by an amount determined by the vibrational modes of the material. There are two types of scattering: Stokes scattering, if the scattered photon has lower energy than that of the incident photon, or anti-Stokes scattering if the scattered photon has gained in energy. For intense pump waves most of the pump energy can be rapidly converted to the Stokes waves inside the medium (the anti-Stokes radiation is much less intense than the Stokes radiation).

In Raman amplification the Stokes wave is amplified by the SRS of the pump wave. Silica glass fibres support a wide range of optical phonon frequencies due to the amorphous nature of the material. This important feature of silica glass allows amplification over a wide Raman bandwidth. For typical germanium-doped silica fibres, the Raman gain spectrum consists of a relatively broad band (up to 40 THz) with a broad peak shifted by 13 THz below the pump frequency, corresponding to a wavelength upshift of about 100 nm at 1500 nm. FIG. 1 shows a typical Raman gain curve as a function of wavelength for germanium-doped silica fibre at a pump wavelength of 1465 nm.

It is possible to use Raman amplification where the signal and the pump are propagating in the same direction, but one can also propagate the pump in the counter-propagating direction, i.e., towards the signal transmitter. The two pumping schemes are denoted by forward (or co-propagating) and backward or (counter-propagating) pumping, respectively. Multiple pump beam at different wavelengths can be used to widen or flatten the gain curve of Raman amplification.

An example of an optical fibre communication system comprising a fibre Raman amplifier is described in U.S. Pat. No. 5,763,280.

Present long-haul communication links make generally use of wavelength division multiplexing (WDM) and zero dispersion or low dispersion fibres to increase capacity and to extend distances between signal regenerations. However, the use of zero- or low-dispersion transmission fibres in WDM systems can result in severe performance degradation due to non linear phenomena, such as four-wave mixing (FWM). In order to minimise FWM the zero-dispersion wavelength should be located out of the transmission bands, normally the C-band (1530-1565 nm) or the L-band (1565-1610 nm). The resulting fibres with a controlled amount of dispersion and low attenuation in the transmission band are called non-zero dispersion-shifted (NZD) fibres, specified in ITU-T Recommendation G.655. Examples of commercial NZD fibres are the TrueWave® (trademark of Lucent Inc), LEAF® and MetroCor® (trademarks of Corning Inc), and FreeLight® (trademark of Pirelli).

Unfortunately, in WDM systems including Raman amplifiers, the zero dispersion wavelength of NDZ fibres often lies in the range of Raman pumping wavelengths, e.g., 1430-1510 nm. This can lead to an increase of noise in the amplified signal due to non-linear parametric amplification phenomena, such as FWM, between the Raman pump(s) and the signal.

EP patent application No. 1130825 describes a transmission fibre designed to limit modulation instability by exhibiting either a non-positive dispersion or a dispersion greater than +1.5 ps/nm/km at any desired pump wavelength. In EP1130825, the presence of FWM is said to be reduced by ensuring that the zero dispersion wavelength of the transmission fibre is not centred between the pump wavelength and signal wavelength.

Applicants have observed that restricting the choice of possible NZD transmission fibres may limit the design of present and future WDM or DWDM (Dense WDM) systems, or limit applicability of Raman amplification in already installed optical systems using NZD fibres.

Sylvestre T. et al. in “Raman-assisted parametric frequency conversion in a normally dispersive single-mode fibre” published in Optics Letters, col. 24, No. 22, p. 1561-1563 (1999), show power-gain enhancement for non-phase-matched waves in a three-wave mixing (TWM) interaction. Large Stokes waves are parametrically generated and then efficiently amplified through the Raman gain by mixing a strong pump with a weak anti-Stokes signal in a normally dispersive single-mode fibre. This phenomenon is called Raman-assisted TWM.

The interaction between an intense pump wave with pulsation ω_{P} and a (weak) anti-Stokes wave of pulsation ω₁=ω_{P}+≠ may induce energy conversion of the anti-Stokes wave into a Stokes wave (idler) of pulsation ω₂=ω_{P}=Ω. In absence of Raman amplification, phase-matching conditions prevents the interaction from occurring in the spectral region where fibre dispersion is significantly different form zero. In this case, the energy exchange increases and decreases periodically along the propagating-fibre so that the mean transferred total optical power is zero. The periodicity of the energy transfer is broken when SRS comes into play. The antisymmetry of the Raman susceptibility induces an efficient frequency conversion of the anti-Stokes wave into the Stokes wave ω₂, also in highly mismatched wave-mixing conditions, i.e., when the fibre is normally dispersive.

Raman amplification requires the use of powerful pump sources to create amplification along the core of the transmission fibre. Semiconductor lasers, such as Fabry-Perot or DFB lasers, are known as pump source for Raman amplifiers. However, output powers of most of present semiconductor lasers, typically 150-200 mW, can be not sufficiently high for applications in long-haul transmission systems, in which an increase of the unrepeated span lengths is desirable.

Among continuous wave (cw) pump sources for Raman amplification, cascaded Raman lasers have gained particular attention because of their high output power and of the possibility of selection of the emission wavelength. Cascaded Raman lasers make use of the cascade effect by which a plurality of Raman shifts in frequency/energy one upon the other can produce a large overall shift in wavelength. Commonly a single radiation wavelength (from a primary source) is introduced and shifted in wavelength, in a multiplicity of stages, to a desired longer wavelength. Frequency-selective elements, e.g., a set of gratings, progressively enhance the power of the shifted resonant wavelengths within the gain medium through several higher-order Stokes lines. The output is typically emitted at a wavelength that corresponds to the highest of the Stokes orders of the pump generated within the pump. Thus, cascaded a man pumps enable Raman amplification over a wide range of different wavelengths. By appropriately selecting the cascaded order of Raman gain, gain can be provided in principle over the entire telecommunication window between 1300 and 1600 nm.

An example of cascaded Raman laser or amplifier is described in U.S. Pat. No. 5,323,404. The disclosed device comprises a length of optical fibre and spaced apart reflecting means that define an optical cavity, with the optical cavity comprising at least a portion of the length of optical fibre. The reflecting, means comprise at least two pairs of reflectors, associated with each of said reflectors is a centre wavelength of a reflection band, wherein the two reflectors, of a given pair have the same centre wavelength, such that the reflectors of a given pair define an optical cavity of length L₁ for radiation of wavelength λᵢ, 1=1,2, . . . ,n₁, n≧2, essentially equal to said centre wavelength of the reflectors. The preferred reflectors in U.S. Pat. No. 5,323,404, are said to be in-line refractive index gratings. All gratings are said to have desirably high reflectivity, with substantially 100%(>98%) reflectivity at the centre wavelength and with FHWM of the reflection curve typically being in the range 2-8 nm. The Raman order n is coupled out by means of a weak reflector coupler.

Another example of cascaded optical fibre Raman described in EP patent application No. 0938172.

Applicants have observed that, also the presence of residual lower-order Raman lines, which have intensity of not more than a few thousands of that of the highest-order line, together with the highest-order emission line can significantly influence the performance of the Raman amplified optical systems.

### SUMMARY OF THE INVENTION

Applicants have found that non-linear phenomena in Raman amplified signals, from a cascaded Raman pump are strongly reduced by substantially suppressing from the output spectrum of the Raman pump the emission, peaks at wavelengths shorter than that of the desired pumping wave on a specific wavelength λₙ, hereby referred also to as the main emission line (peak) or pump wave, and within a given spacing from λₙ. The peaks emitted at shorter wavelength λ₁, . . . , λₙ₋₁ than that of the pump wave are referred to as secondary lines and comprise the residuals of lower-order Raman lines with, possibly, the residual of the primary emission peak from the primary source. Substantial suppression should occur at least for secondary lines which are centred at wavelengths comprised within 250 nm below the wavelength of the main emission line at 80 ₙ, preferably comprised within 350 nm below λₙ. More preferably, all lower-order Raman lines of the output spectrum of the cascade laser are substantially suppressed by means of a wavelength selective element. Substantial suppression from the output spectrum of the secondary lines implies that the secondary lines have an output power which is smaller by more than 40 dB, preferably not smaller by at least 50 dB, more preferably not smaller by at least 60 dB, than that of the main emission line.

In a preferred embodiment, the output power at each wavelength lower than λₙ by less than 250 nm differs more than 40 dB from the output power at λₙ.

Inventors presume that Raman-assisted TWM occurs between the main emission pump wave and a lower-order Raman peak of the spectrum of a cascaded Raman pump, in particular when the zero dispersion wavelength of the transmission fibre lies between the pump wavelength and the signal wavelength. More complex parametric interactions between more than a lower-order Raman peak and the pump wave may also occur. These non-linear phenomena adversely affect the Raman gain through the amplification fibre even though the lower-order Raman peaks are emitted from the Raman pump with an intensity which is much lower than that of the main emission line, e.g., the difference in output power is as large as 20-30 dB.

In one aspect, the invention relates to a pumping module for Raman amplification comprising a cascaded Raman pump source having Raman lines centred at wavelengths λ₁, λ₂ . . . λₙ, n≧2, where the wavelength difference between two adjacent wavelengths corresponds to a stokes shift, and the main mission line is at λₙ while the lower-order Raman lines are at λ₁, λ₂ . . . λₙ₋₁, herein the lower-order Raman lines which are disposed in a wavelength range of less than 250 nm below the main emission line have an output power which is smaller than that of the main emission line by more than 40 dB.

In another aspect, the invention concerns an optical transmission system comprising
a transmitting station for sending an optical signal in a predetermined wavelength range;
an optical fibre transmission line for transmitting the optical signal sent by the transmitting station;
a receiving station for receiving the optical signal transmitted along the optical fibre transmission line;
a pumping module optically coupled to the optical fibre transmission line to pump light in a predetermined wavelength range into at least a portion of the optical along the fibre transmission line to thereby cause Raman amplification of the transmitted optical signal,
characterised in that the pumping module comprises a cascaded Raman pump source having Raman lines centred at wavelengths λ₁, λ₂ . . . λₙ, n≧2, where the wavelength difference between two adjacent wavelengths corresponds to a Stokes shift, and the main emission line is at λₙ, wherein the lower-order Raman lines λ₁, λ₂ . . . λₙ₋₁ disposed in a wavelength range of less than 250 nm from the main emission line have a difference in output power with the main emission line which is larger than 40 dB.

Preferably, the Raman-amplified optical fibre portion in the optical transmission system comprises an optical fibre section having zero dispersion comprised between the wavelength range of the transmitted optical signal and the wavelength range of the main emission pump wave. More preferably, the optical fibre section of the Raman-amplified portion of the optical fibre transmission line has zero dispersion comprised between 1420 and 1520 nm, most preferably between 1430 and 1520 nm.

The invention further relates to a method for amplifying an optical transmission signal comprising
generating a pump radiation by a cascaded Raman process based on the presence of a plurality of Raman lines λ₁, λ₂ . . . , λₙ, n≧2, spaced from each other by a Stokes shift wherein the main emission pump wave is centred at λₙ;
substantially suppressing from the pump radiation the output power of the lower-order Raman lines which are disposed in a wavelength range of at least 250 nm below the main emission line at λₙ;
coupling the pump radiation into an optical fibre so as to cause Raman amplification in the fibre, and coupling the optical transmission signal in the fibre to thereby Raman amplify the transmission signal.

The foregoing drawings illustrate the preferred embodiments of the invention and, together with the description, serve to explain the principles of the invention. It is to be understood that both the drawings and the description are not restrictive of the invention.

### BRIEF DESCRIPTION OF THE DRAWINGS

FIG. 1 Typical measured Raman gain spectrum for germanium-doped silica fibre at a pump wavelength of 1455 nm.

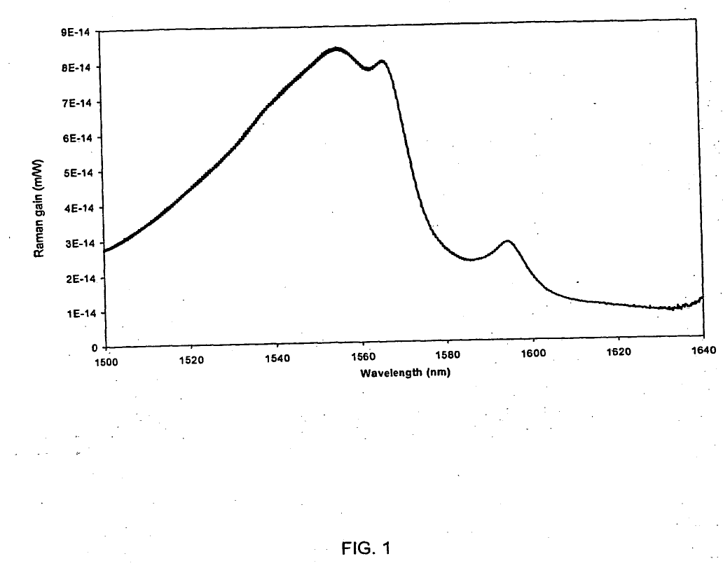

FIG. 2 is a schematic illustration of the experimental set-up for testing the present invention.

FIG. 3 is the power output spectrum in logarithmic scale of a cascaded Raman laser with main emission pump wave at about 1455 nm.

FIG. 4 displays the amplified spontaneous emission (ASE) of a Raman amplifying fibre for a co-propagating Raman pump having the output spectrum of FIG. 3. Measurements were carried out at different pump powers, which range from 100 to 500 mW.

FIG. 5 displays the ASE of a Raman amplifying fibre for a counter-propagating Raman pump having the output spectrum of FIG. 2. Measurements were carried out at different pump powers, which range from 100 to 600 mW.

FIG. 6 is the power output spectrum in logarithmic scale of the cascaded Raman laser of FIG. 3, which was cleared from the secondary emission lines.

FIG. 7 displays the ASE of a Raman amplifying fibre for a co-propagating Raman pump having the output spectrum of FIG. 6, i.e., after suppression of the secondary emission peaks. Measurements were carried out at different pump powers, which range from 100 to 650 mW.

FIG. 8 shows the counter-propagating ASE of a Raman amplifying fibre for the Raman pump with power of 650 mW with the emission spectrum of FIG. 3 (solid line) and with the output spectrum of FIG. 6 (dashed line) in which secondary emission peaks were substantially suppressed.

FIG. 9 is the power output spectrum of a cascaded Raman laser with main emission pump wave at about 1485 nm.

FIG. 10 shows the ASE of a Raman amplifying fibre for the co-propagating Raman pump having the output spectrum of FIG. 9 for a pump power of 150 mW.

FIG. 11 shows an optical transmission system according to the invention.

### DETAILED DESCRIPTION

In a system with distributed Raman amplification, Raman gain and generation of amplified spontaneous emission (ASE) is distributed along the length of transmission fibre. In order to determine the noise performance, it is often useful to consider the equivalent noise figure. The equivalent noise figure NF_{eq} of a distributed Raman amplifier is defined as the noise figure of the equivalent discrete amplifier which is placed at the end of the fibre span and has the same Raman on-off gain G_{ON/OFF} and the same total amplified spontaneous noise power P_{ASE} of the distributed amplifier:

$${NF}_{eq} = \frac{1}{{G}_{ON / OFF}} ( 1 + \frac{{P}_{ASE}}{hv \cdot Δ v} ) \qquad ( 2 )$$

where ν is the signal frequency and Δν is the resolution bandwidth of the detector, e.g., an optical receiver.

The Raman on/off gain G_{ON/OFF} is defined as

$${G}_{ON / OFF} = \frac{{P}_{sOUT}}{{P}_{sIN} \cdot {ⅇ}^{- α L}} \qquad ( 3 )$$

where L is the fibre span length (m), α=ααₛln(10)/10⁴ with as the attenuation coefficient (dB/km) at the signal wavelength, P_{sIN} is the input signal power (W) and P_{sOUT} is the output signal power (W).

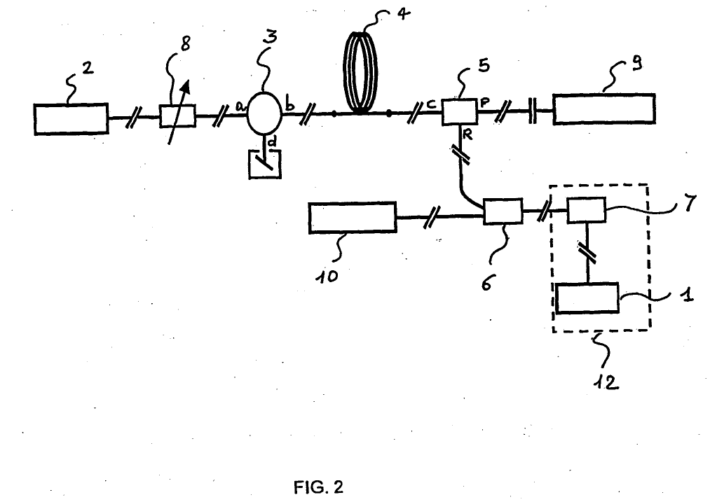

FIG. 2 schematically illustrates an exemplary experimental arrangement of a Raman amplified optical transmission system, which is used to measure the Raman gain and the ASE. A signal source 2 is connected to gate “a” of an optical circulator 3. A variable attenuator 8 is placed between signal source 2 and circulator 3 in order to limit the emitted power that is sent to the input of the amplifier. The signal is guided through gate “b” of circulator 3 into a transmission optical fibre 4. At the opposite end of fibre 4 the amplified signal passes through common port “C” of multiplexer 5. The multiplexer of the present example is a 1480/1550 nm bidirectional monomodal multiplexing device. Reflect port of multiplexer 5 is denoted with “R” and pass port is denoted with “P”. A Raman pumping module 12 comprises a cascaded Raman laser 1 having the main emission line centred at λₙ. The pump signal is injected through a coupler 6 and, through port “R” of multiplexer 5, into fibre 4. The generated on-off Raman gain G_{ON/OFF} is measured by an optical spectrum analyser (OSA) 9 coupled to part “P” of multiplexer 5. In this example, coupler 6 is a 90/10 coupler that attenuates of 0.97 dB through the “90%” port, which is connected to the reflect port “R” of multiplexer 5. The “10%” port of coupler 6 is connected to a power meter 10 that monitors the emitted power of the Raman pump during measurements.

According to an embodiment of the present invention, a wavelength selective element 7, e.g., a filter, is placed in Raman pumping module 12 at the output of the Raman pump source 1. The wavelength selective element performs the substantial suppression of the peaks which can be present in the output spectrum of the cascade laser and which are located at lower wavelengths and within a given wavelength distance from that of the main emission line λₙ. Substantial suppression of the secondary peaks, e.g., lower-order Raman lines, should result in a difference of peak intensity with the main emission line larger than 40 dB, preferably not less than 50 dB and more preferably not less than 60 dB. Substantial suppression should occur at least for lower-order Raman lines which are centred at a wavelength comprised within 250 nm below the wavelength of the main emission line at λₙ, preferably comprised within 350 nm below 4. More preferably, all lower-order Raman lines of the output spectrum of the cascade laser are substantially suppressed by means of a wavelength selective element.

Experiments were carried out also for Raman amplification in a co-propagating pumping scheme. In this case, the experimental set-up of FIG. 2 was modified by connecting the OSA 9 at the port “d” of circulator 3.

### EXAMPLE 1

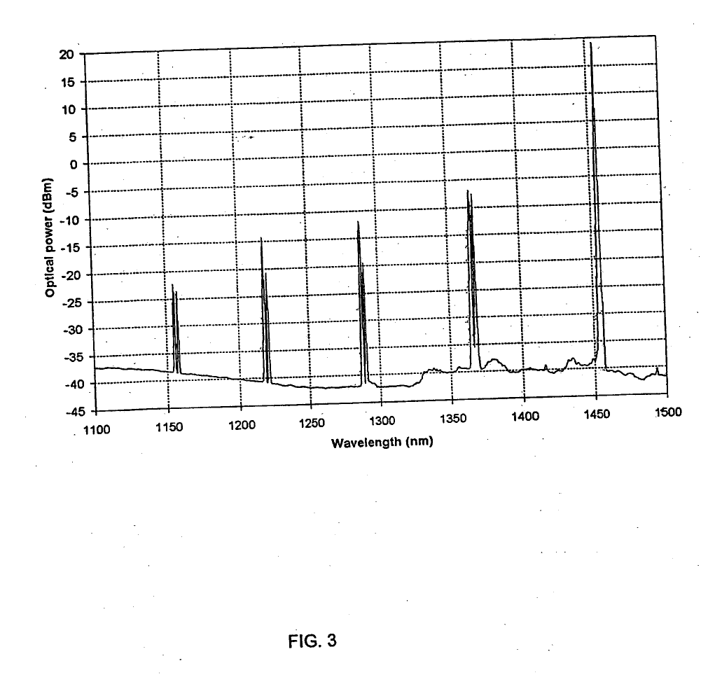

The pump source 1 comprises a cw unpolarised cascaded Raman laser model PYL-1-1455/1486-P commercialised by IPG-Photonics Corporation (USA), which has two selectable cascaded lasers at different emission wavelengths of about 1455 nm and 1485; nm. The emission spectrum of the pump source of this example has the main emission line centred at about 4=1455 nm with full width at half maximum (FWHM) of 2-3 nm and is shown in FIG. 3 for a total pump power of 250 mW at the pump output (spectrum was measured after the coupler 6). Emission lines at lower wavelengths (i.e., lower-order Raman lines) λⱼ=1, . . . , n-1 (n=is), with λₙ₋₁<λₙ, are visible in the spectrum. The difference of intensity between the lower-order Raman lines and the main emission peak at λₙ is about 25-35 dB. In other words, about 98% of the emitted power of the Raman laser of FIG. 3 is concentrated within 2-3 nm about λₙ.

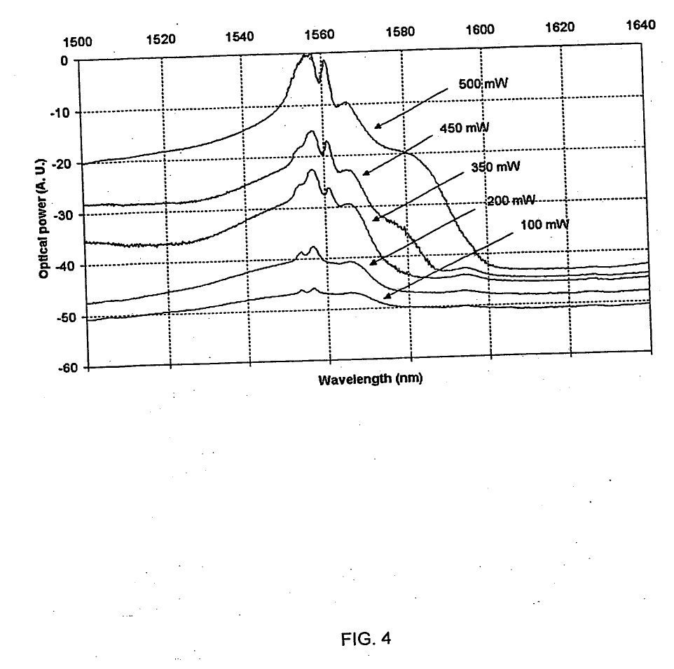

FIG. 4 displays the ASE spectrum in arbitrary units, logarithmic (dB) scale, for a co-propagating Raman pump in an amplifying fibre having the output spectrum of FIG. 3. Measurements were carried out at different pump powers, which ranged from 100 to 500 mW. The transmission fibre for Raman amplification was a NZD fibre having length of about 52 km with zero dispersion of about 1460 nm.

Remarkable anomalies are observed in the ASE curves of FIG. 4 in correspondence to the region of the maximum gain for all pump powers. These anomalies appear in FIG. 4 as sharper peaks overlapping the broad gain curve, especially in the region 1550-1570 nm, and are likely due to parametric gain, i.e., parametric interaction between the pump waves and the signal waves, such as Raman-assisted TWM. A spectrum anomaly is defined in this context as any significant deviation, increase or depletion, of the actual gain curve for an optical fibre from the gain curve due to basically only Raman amplification for the same fibre, i.e., Raman amplification originating substantially from Raman cross-section. A significant deviation of the curve is considered to be about 0.2 dB or more above the experimental noise of the measured ASE curve originating substantially from Raman cross-section.

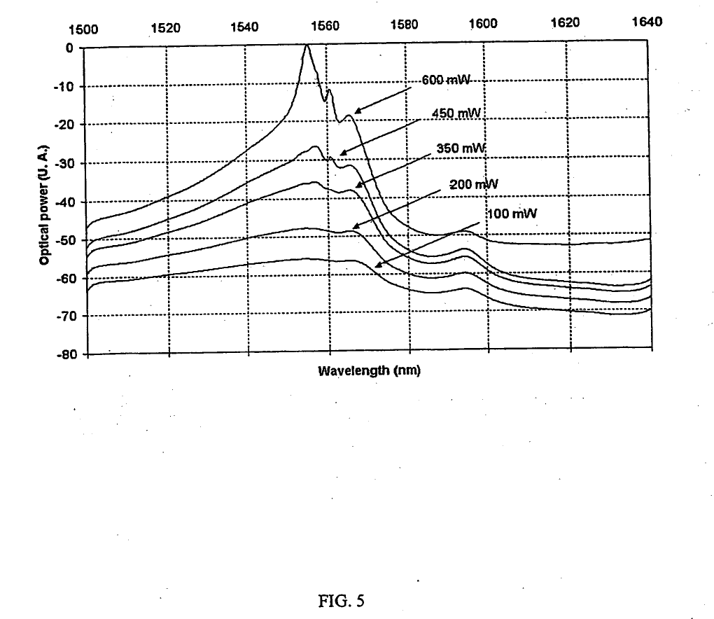

FIG. 5 displays the ASE with the same experimental conditions of those of FIG. 4, but for a counter-propagating Raman pump. Measurements were carried out at different pump powers, which range from 100 to 600 mW. Again, ASE curves exhibit a parametric region with strong anomalies, especially at relatively high pump powers (>350 mW).

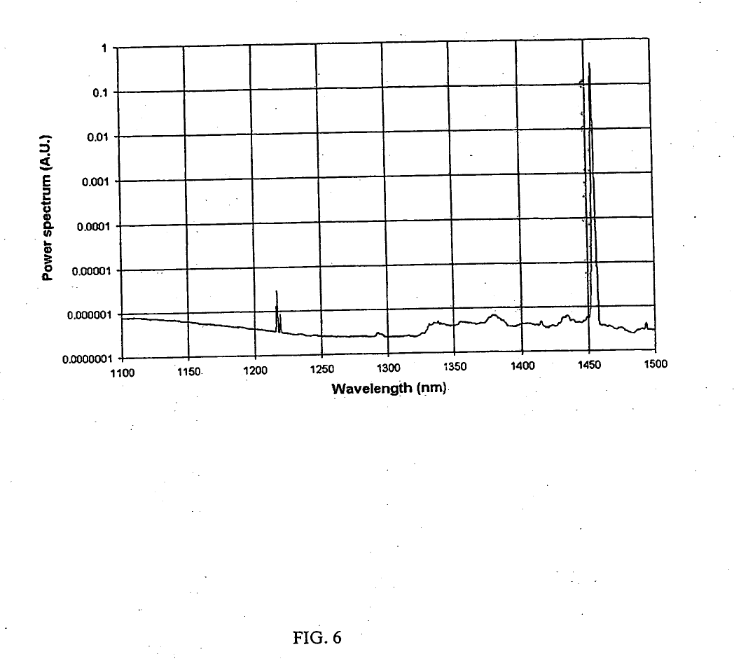

FIG. 6 shows the power spectrum of the cascaded Raman laser having the output spectrum of FIG. 3 but after substantial suppression of secondary lines by means of a wavelength selective element. In the example shown in FIG. 6, the output power spectrum of the Raman cascaded laser is substantially cleared from the lower-order Stokes lines by means of a filter 7 placed at its output. Only a residual peak at about 1220 nm with output power 50 dB smaller than that of the main pump wave is observed in the pump spectrum. In this example, wavelength selection of the pump spectrum has been obtained by placing in front of the pump source 1 two 1480/1550 multiplexing couplers “Pump Mux” commercialised by New Focus (USA) connected in series.

The invention is not restricted to a particular type of wavelength selective element. The wavelength selective element, e.g., filter, should be selected so that to suppress all peaks to at least 250 nm below the main emission wavelength. Other examples of filters suitable to the purpose of the invention are interferential filters or Fabry-Perot filters. Alternatively, wavelength selection suitable to carry out the invention can be physically part of the Raman pumping source, e.g., a filter can be mounted prior the output connector inside the pump housing, or in any other configuration known by the skilled in the art.

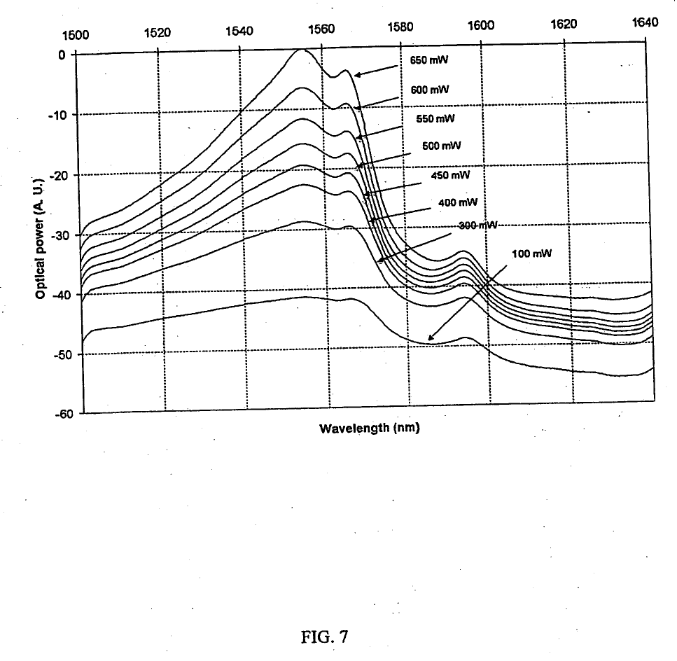

FIG. 7 displays the ASE, in arbitrary units, logarithmic (dB) scale, in a fibre amplifier like that of FIGS. 4 and 5, but for a co-propagating Raman pump having the output spectrum of FIG. 6, i.e., after substantial suppression of the lower-order emission peaks. Measurements were carried out at different pump powers, which ranged from 100 to 650 mW. Anomalies in the region corresponding to the maximum gain have disappeared and, in the region of maximum gain, the ASE curves exhibit the typical shape of a Raman amplified silica fibre.

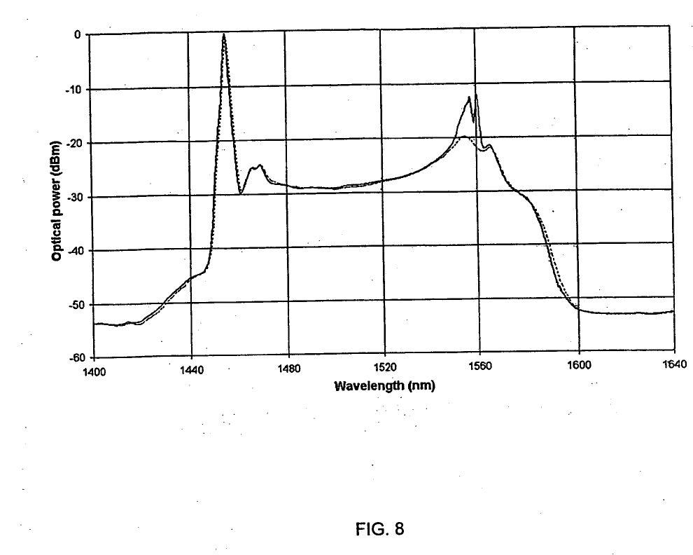

The effect of “cleaning” the power spectrum of the Raman pumping unit can be clearly seen in FIG. 8, where a comparison between the ASE curve for a counter-propagating Raman pump having the spectrum of FIG. 3 and a counter-propagating Raman pump having the spectrum of FIG. 6 is made. The pump power is 650 mW for both pumps and the spectral region ranges between 1400 and 1640 nm. A significant difference between the two ASE curves can be observed, as the curve relative to the pump source including the lower-order Raman peaks (FIG. 3) largely exceeds in power, i.e., up to about 8 dB, the ASE curve relative to the pump having a filtered pump source (FIG. 6), which has the typical shape of a Raman gain curve. The peak at about 1455 nm corresponds to the pump wave. A smaller peak is visible in the ASE curve in the range of about 1460-1470 nm, which corresponds to the zero dispersion of the transmission fibre and it is likely due to modulation instability. The high background of the ASE curves for wavelengths ranging between the pump peak and the region of maximum gain can be attributed to a combination of different non-linear phenomena enhanced by Raman gain.

### EXAMPLE 2

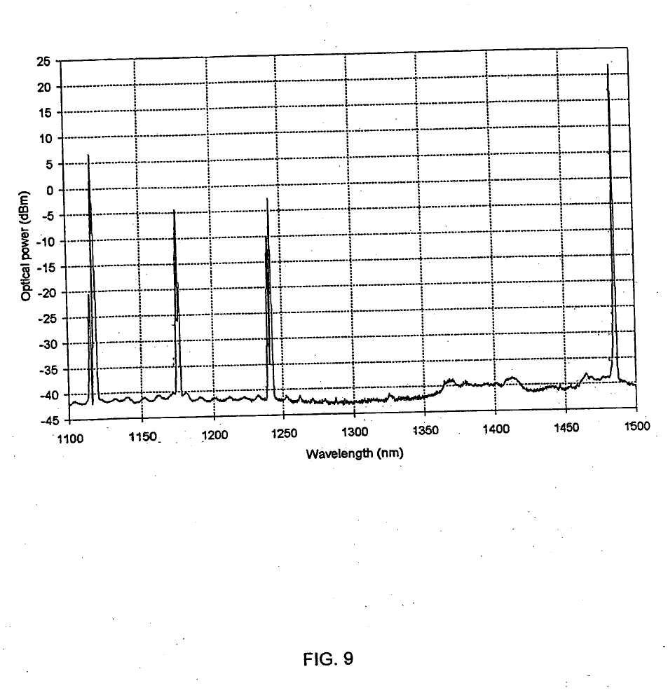

FIG. 9 shows the output power spectrum of a cw cascaded Raman laser commercialised by IPG-Photonics, PYL-1-1455/1486-P, from which the laser with main emission line at about 1485 nm was selected. The in-band optical power, i.e., the power centred at the main emission line, is about 98% of the total emitted power. Three lower-order Raman peaks are present in the spectrum of FIG. 8, which have a peak difference with the main emission line at 1485 nm of about 15-25 dB.

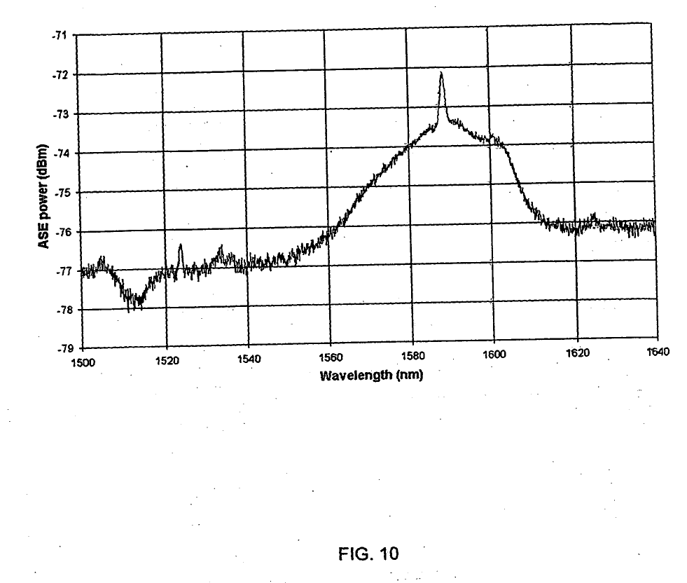

The ASE curve for a co-propagating pump having the output power spectrum of FIG. 9 and pump power of 150 mW is shown in FIG. 10. The transmission fibre for Raman amplification is that of Example 1. A strong anomalous peak is observed in the region of maximum gain, i.e., centred at about 1590 nm, due to parametric gain. This result acquires particular importance if we note that in the output spectrum of FIG. 9, the two first lower-order Raman lines, λₙ₋₁ and λₙ₋₂, are not clearly visible in the spectrum. Nevertheless, Raman gain suffers from non-linear distortions in the maximum gain region. This suggests that all the secondary peaks in the wavelength range of at least 250 nm below the wavelength of the main emission wave (λₙ) should be suppressed for an effective reduction of the non-linear distortions of Raman amplification.

### EXAMPLE 3

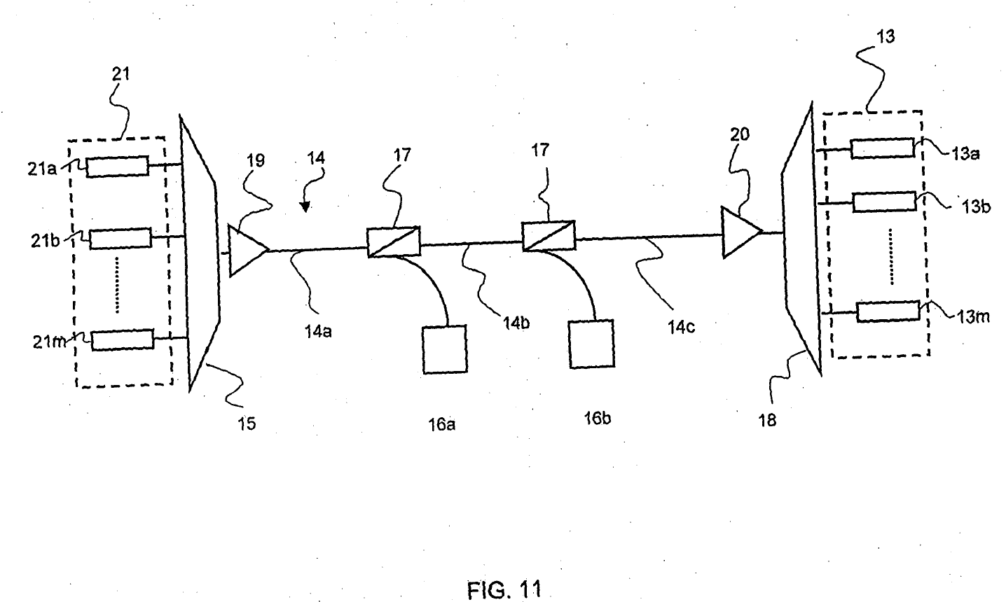

FIG. 11 schematically shows an optical transmission system according to the invention, which comprises a transmitting station 21, adapted to transmit optical signals over an optical fibre transmission line 14, and a receiving station 13, adapted to receive optical signals coming from the optical fibre line 14. The transmitting station 21 comprises a plurality of transmitters 21a, 21b, . . . 21m; m for example 32, 64 or 128. The receiving station 13 comprises a plurality of receivers 13a, 13b . . . , 13m. The transmission system may include transmitting and receiving stations and an optical fibre path for transmitting signals in a direction opposite to the direction of the optical fibre transmission line 14. Terminal and line apparatuses operating in the two directions often share installation sites and facilities.

The transmitters included in the transmitting station 21 provide an optical signal to be coupled into the optical fibre line 14. Typically, each transmitter may comprise a laser source, adapted to emit a continuous wave optical signal having a predetermined wavelength, and an external optical modulator, for example a lithium niobate modulator, adapted to superimpose on the continuous wave optical signal emitted by the laser source a traffic signal at a predetermined high frequency or bit rate, such as for example 10 Gbit/s or 40 Gbit/s. Alternatively, the laser source may be directly modulated with the traffic signal. A preferred wavelength range for the optical signal radiation is between about 1460 nm and about 1650 nm. Each transmitter may also comprise a variable optical attenuator, adapted to set a predetermined power level for each signal wavelength (pre-emphasis level). The different signal wavelengths emitted by the plurality of transmitters are multiplexed by multiplexing device 15. Such multiplexing device can be any kind of multiplexing device (or combination of multiplexing devices), such as a fused fibre or planar optics coupler, a Mach-Zehnder device, an AWG (Arrayed Waveguide Grating), an interferential filter, a micro-optics filter and the like.

Each receiver is adapted to convert an incoming optical signal in an electrical signal. A demultiplexing device 18 allows to separate the different signal wavelengths from a single optical path to a plurality of optical paths, each terminating with a receiver. The demultiplexing device can be any kind of demultiplexing device (or combination of demultiplexing devices), such as a fused fibre or planar optics coupler, a Mach-Zehnder device, an AWG (Arrayed Waveguide Grating), an Interferential filter, a micro-optics filter or the like.

The optical system can comprise also a post-amplifier 19 at the transmitter end and/or a pre-amplifier 20 before the receiving station. Where necessary, dispersion compensating modules, e.g., a dispersion-compensating fibre, may be included in the optical system so as to compensate the accumulated dispersion in a fibre span or after one or more fibre spans.

The optical fibre transmission line 14 comprises at least one transmission optical fibre. The transmission optical fibre used in the optical fibre line 14 is a single mode fibre.

A plurality of N optical pumping modules according to the invention is disposed along the optical fibre line 14, so as to divide the optical fibre line 14 in a plurality of fibre spans. In FIG. 11 only three fibre spans are shown. Two pumping modules 16a and 16b are disposed along the optical fibre line 14, so that fibre spans 14a, 14b and 14c may be identified. Fibres 14a and 14b are counter-pumped by pumping modules 16a and 16b, respectively, and WDM couplers 17 to provide distributed amplification along the fibre lengths. Each of modules 16 comprises a cascaded Raman pump source and a wavelength selecting element that act so that the output power spectrum of the optical pumping module has a main emission line at the pump wave which differs from the lower-order Raman lines situated in the wavelength range of at least 250 nm below the pump wave wavelength of more than 40 dB.

In a preferred embodiment, the fibre spans 14a and 14b are nonzero dispersion (NZD) fibres, with zero dispersion wavelength between about 1420 and 1520 nm, preferably between 1430 and 1510 nm.

Of course, in the above example of optical transmission system a co-propagating pumping scheme can be also considered.

Although the above detailed description refers to a distributed Raman amplification, the invention can be applied generally to optical systems that use Raman amplification and comprise a cascaded Raman pump source. For instance, optical systems comprising discrete Raman amplifiers can be contemplated as a possible application of the invention. In case of discrete Raman amplifiers, the optical pumping module is included in an optical gain module that comprises an amplifying medium, e.g., a length of optical fibre.

Furthermore, the invention can be applied to optical systems comprising hybrid amplifiers including at least a lumped amplifier, such as EDFA and TDFA (TDFA=Thulium-doped fibre amplifier), and a distributed or discrete Raman amplifier.

1-16. (canceled)

17. A pumping module for Raman amplification comprising a cascaded Raman pump source having Raman lines centered at wavelengths λ₁, λ₂ . . . λₙ, n≧2, wherein the wavelength difference between two adjacent wavelengths corresponds to a Stokes shift, and the main emission line is at λₙ while the lower-order Raman lines are at λ₁, λ₂ . . . λₙ₋₁, and wherein the lower-order Raman lines which are disposed in a wavelength range of less than 250 nm below the main emission line have an output power which is smaller than that of the main emission line by more than 40 dB.

18. The pumping module of claim 17, wherein the lower-order Raman lines disposed in a wavelength range of less than 350 nm below the main emission line have a difference in output power of more than 40 dB with respect to the main emission line.

19. The pumping module of claim 17, wherein each of the lower-order Raman lines has a difference in output power with the main emission line which is larger than 40 dB with respect to the main emission line.

20. The pumping module of claim 17, wherein the output power at each wavelength lower than λₙ by less than 250 nm differs by more than 40 dB from the output power at λₙ.

21. The pumping module of claim 17, wherein the difference in output power between the main emission line and the lower-order Raman lines is not smaller than 50 dB.

22. The pumping module of claim 17, wherein the difference in output power between the main emission line and the lower-order Raman lines is not smaller than 60 dB.

23. The pumping module of claim 17, further comprising at least a wavelength selecting element.

24. An optical transmission system comprising:
a transmitting station for sending an optical signal in a predetermined wavelength range;
an optical fibre transmission line for transmitting the optical signal sent by the transmitting station;
a receiving station for receiving the optical signal transmitted along the optical fibre transmission line;
a pumping module optically coupled to the optical fibre transmission line to pump light in a predetermined wavelength range into at least a portion of the optical fibre along the fibre transmission line to thereby cause Raman amplification of the transmitted optical signal,
the pumping module comprising a cascaded Raman pump source having Raman lines centered at wavelengths, λ₁, λ₂ . . . λₙ, n≧2, wherein the wavelength difference between two adjacent wavelengths corresponds to a Stokes shift, and the main emission line is at λₙ, wherein the lower-order Raman lines λ₁, λ₂ . . . λₙ₋₁ disposed in a wavelength range of less than 250 nm from the main emission line have a difference in output power with the main emission line which is larger than 40 dB.

25. The optical transmission system of claim 24, wherein the lower-order Raman lines disposed in a wavelength range of less than 350 nm from the main emission line have a difference in output power of more than 40 dB.

26. The optical transmission system of claim 24, wherein each of the lower-order Raman lines have a difference in optical power with the main emission line which is larger than 40 dB.

27. The optical transmission system of claim 24, wherein the difference in output power between the main emission line and the lower-order Raman lines is not smaller than 50 dB.

28. The optical transmission system of claim 24, wherein the difference in output power between the main emission line and the lower-order Raman lines is not smaller than 60 dB.

29. The optical transmission system of claim 24, wherein the Raman-amplified portion of the optical fibre transmission line comprises an optical fibre section having zero dispersion between the wavelength range of the transmitted optical signal and the wavelength range of the main emission pump wave.

30. The optical transmission system of claim 29, wherein the optical fibre section of the Raman-amplified portion of the optical fibre transmission line has zero dispersion between 1420 and 1520 nm.

31. The optical transmission system of claim 30, wherein the optical fibre section of the Raman-amplified portion of the optical fibre transmission line has zero dispersion between 1430 and 1510 nm.

32. A method for amplifying an optical transmission signal comprising:
generating a pump radiation by a cascaded Raman process based on the presence of a plurality of Raman lines λ₁, λ₂ . . . λₙ, n≧2, spaced from each other by a Stokes shift wherein the main emission pump wave is centred at λₙ;
substantially suppressing from the pump radiation the output power of the lower-order Raman lines which are disposed in a wavelength range of at least 250 nm below the main emission line at kn;
coupling the pump radiation into an optical fibre so as to cause Raman amplification in the fibre; and
coupling the optical transmission signal in the fibre to thereby Raman amplify the transmission signal.
